(19) United States
(12) Patent Application Publication
(10) Pub. No.: US 2005/0218233 A1
(43) Pub. Date: Oct. 6, 2005

(54) Recording tag and reading system

(75) Inventors: Michael Petersen, Ottawa, ON (CA); Allan Wilson, Ottawa (CA)

Correspondence Address: JONES, TULLAR & COOPER, P.C., P.O. BOX 2266 EADS STATION, ARLINGTON, VA, 22202, US

(73) Assignee: Intelligent Devices, Inc., Christ Church (BB)

(21) Appl. No.: 10/512,439

(22) PCT Filed: Apr. 23, 2003
(86) PCT No.: PCT/CA03/00585

§ 371 Date: Apr. 25, 2005

(30) Foreign Application Priority Data
Apr. 23, 2002 (CA) 2,383,049

(51) Int. Cl. G06K 19/06; G07B 15/02; G06F 17/60

(52) U.S. Cl. 235/492; 235/385; 235/384

(57) ABSTRACT

A tag that can be mounted to or within an article has means for sensing one or more conditions associated with the article, such as temperature, shock, radiation or atmosphere. The tag also includes power means such as a thin film battery, transducer means, data storage means, and means for transmitting data or information to a suitable receiver. The tag will accompany the article in transit or in storage and be able to inform an interested party of conditions experienced by the article. The tag can be programmed to sense conditions at specific time intervals, making use of an internal clock. The clock, data storage means, transducer means and transmission means can all be part of a thin film integrated circuit incorporated on the tag.

The present invention relates to a system that includes a sensing and recording tag and a reader/writer that can instruct the tag and can read data created during use of the tag. The system will be utilized primarily in the transport and storage field to detect changes in the environment pertaining to products that are being shipped or stored.

### BACKGROUND OF THE INVENTION

Tags, strips or badges which will detect a condition change are well known. For example, people working around nuclear reactors, laboratories, factories, hospitals, etc. where nuclear radiation may be present wear badges which will change colour if the badge is exposed to dangerous levels of radiation. They may progressively change colour as the radiation builds up or they may change colour dramatically if they are exposed to a sudden potentially lethal dose of radiation. Other badges or tags are provided with chemical detecting material so that they will change colour in the presence of a potentially dangerous chemical or gas, such as chlorine. Yet other badges or tags may change colour as the result of a change in temperature over or below a set threshold. These tags may be worn by an individual or they may be stuck to or placed within a product or package or container so that someone later on can ascertain whether the product, package, or container was subjected to inappropriate environmental conditions, including inappropriate temperatures. Such tags may have importance with respect to products whose quality or shelf life, as in the case of foodstuffs, could be adversely affected by inappropriate environmental conditions.

Tags such as those described above are generally inexpensive as they are designed to record a single event or condition. Generally they cannot be reused once they have recorded the significant event but that is not a problem given that they are inexpensive. They may be termed as being disposable tags or detectors.

There are instances where it is desirable to be able to trace and record multiple events during the transport of a product or load and/or during the storage of such a load. Sensing and recording devices which will accomplish this are available; they include multiple sensors, a clock, a battery, a memory in which sensed data is recorded, and some form of output mechanism whereby the recorded data can be read for interpretation by an interested party. These devices, unfortunately, tend to be large in size in comparison to the disposable tags mentioned above, being as large as a cigarette package or even larger. They also tend to be very expensive, on the order of $200 each in comparison to the $1 cost of a disposable tag. On the other hand these devices are reusable which tends to offset their high initial cost.

It is apparent from the foregoing that there is a need for a multi-use sensing and recording tag that benefits from the small size of a disposable tag, which will perform the functions of the large-size multi-function device, and which will be much closer in cost to that of the disposable tag.

### SUMMARY OF THE INVENTION

The present invention overcomes the problems of the prior art and meets the criteria set forth hereinabove. The invention contemplates in one aspect a reusable tag that can be attached to the exterior of a product, article, package or container or can be incorporated therewithin. The tag makes use of current and emerging technology relating to thin film power supplies, possibly including rechargeable thin film batteries, as well as thin film integrated circuit technology. A tag of this invention will be able to sense at least one of a plurality of environmental conditions, including temperature, atmosphere, and shock; may have built-in clock function so that the exact time that an event takes place will be recorded; sufficient memory to ensure that all events will be recorded; and may have means for transmitting recorded data or for permitting recorded data to be downloaded from its memory for later use. The tag may also be programmable and will be provided with a identifier to aid in assuring that the information therein pertains to a particular job.

While a multi-functional, multi-use tag is contemplated by this invention it should be realized that the same technology can be a single-use item, preprogrammed at the factory to detect and record specific events, and to transmit or give up the recorded data when signalled to do so. Once the data has been read the tag would be destroyed as it could not be re-used at all.

The system of the invention will include a reader/writer that can be programmed to read and display information gathered by the tag during its use. Such device could be used to reset the tag to “zero” so that it would be ready to record data for another project or job and could also be used to recharge the tag's battery if necessary. The reader/writer could also be used to program the tag for its particular job, depending on the data that will be needed at the end.

### DESCRIPTION OF THE INVENTION

In its most basic form the present invention includes a sensing/recording tag used to acquire data and a reader used to download data from the tag. The tag itself will be of a small size, comparable to a credit card, or even smaller. It will be very thin and light, and it can be rigid, semi-rigid or flexible. Preferably it will be formed from a material that is very strong, will offer considerable resistance to cutting or tearing, and will be resistant to the deleterious effects of heat, cold, magnetism, chemicals and radiation. Such materials already exist and are well within the knowledge of skilled materials engineers. The material should also be capable of being adhered to the inside or the outside of a shipping container or a package.

The tag will be provided with a thin film battery as a power supply. Such thin film batteries already exist and are being further developed at a prodigious rate. A disposable tag would include a single or limited use battery whereas a reusable tag would use a rechargeable battery. It would be expected that a disposable tag would be less expensive to produce than a reusable tag.

The tag would also be provided with a programmable integrated circuit connected to the battery and which would include a clock, a series of sensors, and a memory for storing data derived from the sensors. The sensors could be programmed either at the factory or by the reader, if the reader is provided with a writing capability, to react to changes in temperature, position, atmosphere, impact, etc., with each change being recorded in the memory only if, for example, it exceeded a pre-set threshold. Whenever a recordable event is detected it would be recorded in the appropriate section of the memory relating to such events and the time that the event took place would be recorded as well, being associated with that particular event. It would not be necessary that the clock record the exact time that the recordable event took place; it would be sufficient for the clock to identify the nearest quarter hour, for example. It is likely that for jobs taking a long time, of days or weeks, the event timing can be coarser than for jobs of short duration. In the latter case it would be more desirable to record the exact time, say to the closest minute, at which an event took place. The accuracy of the timing can be pre-set from a list of criteria whenever the tag is programmed.

Included in the integrated circuit will be a specific identifier code for each tag so that the tag can be identified by a reader/writer used by the people interested in the data developed by the tag. The tag could be initially programmed at the factory to perform specific desired functions or the tag might be set up so that it could be programmed “on the job”. In the latter case the reader/writer would be used to initially program the tag using a number of selectable criteria. The reader/writer will be provided with reading means for downloading the data from the tag at the end of a job. For this, the tag will also be provided with output means that can be coupled directly or indirectly to the reader/writer whereby the data recorded in memory can be transferred to the reader/writer for display and/or later use. The reader/writer can also be provided with means for recharging the battery of the tag if it is provided with a rechargeable thin film battery.

A disposable tag in accordance with this invention would likely cost in the vicinity of $3, a little more than existing single use tags. A reusable tag would be more expensive, perhaps in the vicinity of $8 each. Conceivably if a food merchant, for example, were to purchase reusable tags and several reader/writers in order to monitor shipments of produce from a country of origin to his warehouse in Canada he would have no need to purchase additional tags once his initial supply had been obtained. This would mean that the supplier of tags and reader/writers would have a limited market for tags, since once each of his customers had acquired its initial supply there would be no requirement for the customers to purchase more tags, except as replacements for lost or destroyed tags, or to accommodate an increase in business.

It is therefore an additional feature of the tags of this invention, in particular for the reusable tags, that each such tag will be “licensed” rather than sold to the customer so that the tag manufacturer can be assured of continuous income therefrom. Each tag or the licensed reader/writer would be provided with a countdown register so as to permit only a limited number of uses before the identified tag could no longer have its recorded data downloaded by a reader/writer. The number of uses would be associated with the particular identifier given to the particular tag at the factory and each reader/writer would have an identifier associated therewith known only to the manufacturer. When a tag has reached the end of its preprogrammed “life” the customer would contact the manufacturer and would “buy” another packet of uses for that tag. The manufacturer would provide the customer, after payment, with a special code that could be transmitted to the tag by the customer's reader/writer and which would reactivate that tag for the specific number of uses then purchased by the customer. In this manner the manufacturer would be assured of continuous income from reusable tags.

The manufacturer could alternatively manufacture non-programmable tags having sufficient battery power to meet a customer's requirements for, say, ten jobs of the same nature. The battery and the sensors would lie dormant until the customer's reader/writer is used to activate the tag, the activated tag then being used until it reaches the end of its preprogrammed life. The tag could not be reactivated and it would then be necessary for the customer to purchase a new tag as a replacement for the dead tag.

The tags can be provided with passive or active data transmission means, including RF (radio frequency) transmission, as is known in the art.

The manufacturer would have the ability to license the software that controls the reader/writer in order to exercise control over the activities of the licensees to thereby thwart unauthorized use of the tags or the reader/writers. The software would be developed so as to be adapted to the customer's particular needs, whether that need includes simple results, such as whether a particular predetermined temperature was exceeded, or more complex results, such as a timed log of environmental conditions including vibration, etc.

The foregoing has broadly described the present invention as currently contemplated, it being understood that a skilled person in this art could undoubtedly effect changes thereto without departing from the spirit of the invention itself.

1. A self-contained tag for use with an article for sensing one or more conditions associated with said article, said tag including power means, condition sensing means, transducer means, information storage means, and information transmission means, whereby said transducer means converts a condition sensed by said sensing means into a signal that can be stored by said storage means for eventual transmission to a reader.

2. The tag of claim 1 wherein said power means includes a thin film battery incorporated in said tag and said condition sensing means, said transducer means, said storage means and said transmission means are incorporated in a thin film integrated circuit included in said tag.

3. The tag of claim 1 wherein said condition sensing means is programmed to sense one or more conditions from the group of conditions including temperature, atmosphere, magnetic fields, radiation, shock and acceleration.

4. The tag of claim 3 wherein said integrated circuit includes clock means for recording the time at which a condition is sensed.

5. The tag of claim 4 wherein said clock means can be programmed to control said condition sensing means such that a condition is sensed at specific intervals.

6. The tag of claim 1 including receiver means connected to said condition sensing means for activating said tag.

7. The tag of claim 1 including means for mounting said tag to the exterior or within the interior of the article.

8. The tag of claim 2 wherein said battery is rechargeable.

9. The tag of claim 2 wherein said integrated circuit includes electronic means for identifying the tag and differentiating it from other similar tags.

10. The tag of claim 1 wherein said transmission means is selected from the group of transmission means including active and passive data transmission means.

11. The tag of claim 10 including antenna means for transmitting data held in said storage means to a reader external to said tag.

12. The tag of claim 10 including contact means for transmitting data held in said storage means to a reader external to said tag.

13. The tag of claim 2 wherein said integrated circuit can be programmed to sense specific conditions, to transmit data stored in said storage means, and to effect said sensing and transmission at specific timed intervals.

14. A system for sensing, recording and transmitting condition information with respect to an article, comprising a tag and a reader, said tag including power means, condition sensing means, transducer means, information storage means, and information transmission means, whereby said transducer means converts a condition sensed by said sensing means into a signal that can be stored by said storage means for eventual transmission to said reader, and said reader including receiver means, storage means, and display means for accepting information from said tag and displaying said information for use by an interested party.

15. The system of claim 14 wherein said reader includes means for imparting programming information to a tag.

16. The system of claim 14 wherein said reader includes wireless transmission means for transmitting programming information to a tag and wireless receiver means for receiving stored information from a tag.
